(19) United States
(12) Patent Application Publication
(10) Pub. No.: US 2009/0152212 A1
(43) Pub. Date: Jun. 18, 2009

(54) SYSTEMS AND METHODS FOR TREATMENT OF GROUNDWATER

(76) Inventors: Robert L. Kelsey, Fair Oaks Ranch, TX (US); Qiwei Wang, San Antonio, TX (US)

Correspondence Address: MEYERTONS, HOOD, KIVLIN, KOWERT & GOETZEL, P.C., P.O. BOX 398, AUSTIN, TX, 78767-0398, US

(21) Appl. No.: 11/736,994

(22) Filed: Apr. 18, 2007

(51) Int. Cl. C02F 1/00; B01F 5/02

(52) U.S. Cl. 210/787; 210/512.2

(57) ABSTRACT

Systems and methods to treat contaminated water are described herein. A contaminated water treatment system may include a reservoir and/or one or more fluid treatment systems.

### BACKGROUND

1. Field of the Invention

The present invention relates to treating groundwater. More particularly, the invention relates to treating groundwater using a hydrodynamic cavitation system.

2. Brief Description of the Related Art

Groundwater may become contaminated with chemicals from agricultural uses and spillage from industrial sites. Groundwater remediation may include removal of chemical compounds that render the groundwater unfit for use as potable water and/or agriculture purposes. Consequently, the clean up and removal of the chemical compounds from the groundwater is desired. Chemical compounds may be removed through remediation. Techniques for remediation of groundwater may include ex situ treatments and/or in situ treatments.

In situ treatment of groundwater may include sparging, bioremediation, chemical oxidation, phytoremediation, and natural attenuation. U.S. Pat. No. 6,827,861 to Kerfoot, which is incorporated herein by reference, describes a sparging system for groundwater and soil remediation.

Ex situ treatment may include, pumping contaminated water from extraction wells, followed by water treatment. Water treatment may include air stripping and/or activated carbon adsorption. Due to the low carbon adsorption capacity of groundwater contaminants onto the carbon, carbon adsorption may not be cost effective. U.S. Pat. No. 5,352,276 to Rentschler et al., which is incorporated herein by reference, describes the removal of methyl tertiary-butyl ether, tertiary-butyl alcohol and/or volatile organic compounds from groundwater using a portable modular stripping system.

Air stripping may require injection of tens to hundreds of volumes of air per volume of water stripped, deterioration in treatment efficiency during cold weather due to the chilling effect of the cold air, and/or scale formation on the stripper packing media. Scale formation may effect air stripping efficiency and requires frequent acid washing of the stripper packing media for descaling. Thus, improved methods for removal of chemical compounds and other contaminates are desired.

### SUMMARY

Systems and methods to treat contaminated water are described herein. The contaminated water may include contaminated ground water and/or contaminated surface water. In some embodiments, an amount of volatile organic compounds may be reduced and/or controlled to acceptable parts per billion (ppb) levels with or without the use of additives in conjunction with a fluid treatment system. A fluid treatment system includes a first vortex nozzle unit and a second vortex nozzle unit positioned opposed to the first vortex nozzle unit. The contaminated water stream is introduced into the fluid treatment system. A first portion of the contaminated water stream flows through the first vortex nozzle unit and a second portion of the contaminated water stream flows through the second vortex nozzle unit. The contaminated water stream exiting the first vortex nozzle unit contacts the second portion of the contaminated water stream exiting the second vortex nozzle unit. Contact of the contaminated water stream exiting the first vortex nozzle unit with the contaminated water stream exiting the second vortex nozzle unit removes at least a portion of one or more volatile organic compounds in the contaminated water.

In some embodiments, the fluid treatment system is coupled to a reservoir. A conduit may couple the reservoir to an inlet of the fluid treatment system. An additional conduit may couple the fluid treatment system back to the reservoir. During use, at least a portion of the treated contaminated water exiting the fluid treatment system may be sent to the reservoir or distributed to other processing and/or storage units.

In some embodiments, a fluid treatment system includes one or more vortex nozzle units. Each vortex nozzle unit may include a single pair of vortex nozzles or multiple vortex nozzle units. In some embodiments, a pair opposed vortex nozzle units (a first vortex nozzle and a second vortex nozzle unit). In an embodiment of a fluid treatment system, the first vortex nozzle unit has a plurality of vortex nozzles. When a vortex nozzle unit includes a plurality of vortex nozzles, the vortex nozzles may be arranged in a cascade configuration. In some embodiments, a fluid treatment system includes a screen coupled to the inlet of the fluid treatment system.

In some embodiments, the reduction of volatile organic compounds in contaminated water may be modified by introducing an additive to the fluid treatment system. In some embodiments, the additive includes hydrogen peroxide or a hydrogen peroxide precursor.

### BRIEF DESCRIPTION OF THE DRAWINGS

Features and advantages of the methods and apparatus of the present invention will be more fully appreciated by reference to the following detailed description of presently preferred but nonetheless illustrative embodiments in accordance with the present invention when taken in conjunction with the accompanying drawings in which:

FIG. 1 depicts a top view of an embodiment of a fluid treatment system;

FIG. 2 is a cross-sectional view of the fluid treatment system depicted in FIG. 1 taken substantially along line 2-2;

FIG. 3 is a perspective view of a fluid treatment system;

FIG. 4 is a cross-sectional view of the fluid treatment system depicted in FIG. 3 taken substantially along plane 4-4;

FIG. 5 is a perspective view illustrating a vortex nozzle of the apparatus for treating fluids;

FIG. 6 is an alternate perspective view illustrating a vortex nozzle of the apparatus for treating fluids;

FIG. 7 is an end view illustrating an inlet side of a vortex nozzle body of the vortex nozzle;

FIG. 8 is a cross-sectional view of FIG. 5 taken substantially along lines 8-8 illustrating the vortex nozzle body of the vortex nozzle;

FIG. 9 depicts a graph denoting the change in biological contaminants (i.e., E. coli) during multiple passes through a fluid treatment system;

FIG. 10 depicts a graph denoting the change in biological contaminants (i.e., heterophic bacteria) during multiple passes through a fluid treatment system;

FIG. 11 depicts an embodiment of treating contaminated water that includes a fluid treatment system in combination with a reservoir;

FIG. 12 depicts an embodiment of treating contaminated water with a fluid treatment system;

While the invention is susceptible to various modifications and alternative forms, specific embodiments thereof are shown by way of example in the drawings and will herein be described in detail. The drawings may not be to scale. It should be understood that the drawings and detailed description thereto are not intended to limit the invention to the particular form disclosed, but to the contrary, the intention is to cover all modifications, equivalents and alternatives falling within the spirit and scope of the present invention as defined by the appended claims.

### DETAILED DESCRIPTION

Systems and methods for treating contaminated water are described herein.

Selected terms used herein are listed below.

“Contaminated water” refers to groundwater and/or surface water that is not suitable as a potable water supply and/or for agricultural purposes. Contaminated water may include, but is not limited to, water containing dissolved gases, halogenated hydrocarbons, volatile organic compounds or mixtures thereof, and water containing harmful (pathogenic) bacteria.

“Groundwater” refers to liquid and/or water located beneath the Earth's surface.

“Streams” refer to a stream or a combination of streams. The term fluid and/or stream may be used interchangeably.

“Surface water” refers to liquid and/or water located at or above the Earth's surface.

“Volatile Organic Compounds” (VOCs) refer to any organic compound, except for methane and ethane, with a vapor pressure of at least 13.3 Pascal. Examples, of VOCs include, but are not limited to, ether oxygenates, and alcohol oxygenates, hydrocarbons, and halogenated organic compounds. Examples of ether oxygenates include, but are not limited to, methyl tertiary-butyl ether (MTBE), tertiary-amyl methyl ether, dimethyl ether, ethyl tertiary-butyl ether, tertiary-amyl ethyl ether, and diisopropyl ether. Examples of alcohol oxygenates include, but are not limited to, tertiary-butyl alcohol (TBA), ethanol (ETOH), methanol (MeOH), and tertiary-amyl alcohol (TAA). Examples of hydrocarbons include, but are not limited to, benzene, ethyl benzene, styrene, toluene, and xylenes (3TEX). Examples, of halogenated hydrocarbons include, but are not limited to, carbon tetrachloride, trichloroethanes, dichloroethane, trichloroethylene, tetrachlorethylene, dichlorethylenes, dichloropropane, methylene chloride, chlorobenzenes, trichlorobenzene, and vinyl chloride.

It is to be understood that the terminology used herein is for the purpose of describing particular embodiments only, and is not intended to be limiting. As used in this specification, the singular forms “a”, “an” and “the” include plural referents unless the content clearly indicates otherwise. Thus, for example, reference to “a nozzle” includes a combination of two or more nozzles and reference to “bacteria” includes mixtures of different types of bacteria.

Groundwater and/or surface water may include one or more chemical compounds (e.g., VOCs, halogenated hydrocarbons, or dissolved gases) that may render the groundwater unsuitable for use. Remediation of groundwater may include removing at least a portion of the groundwater from the ground and providing the contaminated water to a treatment unit. In the treatment unit, the contaminated water may be physically treated (e.g., sparging), chemically treated, and/or biologically treated to remove one or more contaminants from the water. Incorporating one or more fluid treatment systems in the treatment unit may efficiently reduce the need for sparging. In some embodiments, the fluid treatment system may be a hydrodynamic cavitation system marketed by VRTX Technologies (Schertz, Tex.). In certain embodiments, a fluid treatment system may be positioned near or adjacent to the treatment system.

In certain embodiments, a fluid treatment system includes a first vortex nozzle unit positioned in opposed relationship to a second vortex nozzle unit, and a pressure-equalizing chamber that delivers a flow of a stream to each of the nozzle units. As used herein the term “vortex nozzle unit” refers to a single vortex nozzle or a plurality of vortex nozzles coupled together. The pressure-equalizing chamber receives a stream from a pump and delivers the stream into the first vortex nozzle unit and the second vortex nozzle unit. The first and second vortex nozzle units receive the stream therein and impart rotation to the stream, thereby creating a first rotating stream and a second rotating stream, respectively. The fluid treatment system further includes a collision chamber where impingement of the first rotating stream flow with the second rotating stream flow occurs.

In some embodiments, a fluid treatment system may include two sets of opposed cascaded vortex nozzles. For example, a vortex nozzle unit may include a cascaded vortex nozzle pair, which includes a first vortex nozzle having a second vortex nozzle cascaded within it. The vortex nozzle unit further includes a second cascaded vortex nozzle pair, which includes a third vortex nozzle having a fourth vortex nozzle cascaded within it. More particularly, the outlet from the second nozzle communicates with an inlet into the first nozzle and the outlet from the fourth nozzle communicates with an inlet into the third nozzle. Each of the four vortex nozzles receives a fluid through an inlet that communicates with a stream to impart a rotation to the stream passing through the nozzles. The cascaded vortex nozzles are positioned in opposed relation and communicate with a chamber so that the streams exiting the nozzles rotate in opposite directions to collide at approximately the mid-point of the chamber. The two counter-rotating streams exiting the nozzles collide at high velocity to create a compression wave throughout the fluid.

Hydrodynamic cavitation systems and other fluid treatments systems are described in U.S. Pat. Nos. 4,261,521 to Ashbrook; 4,645,606 to Ashbrook et al.; 4,722,799 to Ashbrook et al.; 4,764,283 to Ashbrook et al.; 4,957,626 to Ashbrook; 5,318,702 to Ashbrook; 5,435,913 to Ashbrook; 6,045,068 to Ashbrook; 6,649,059 to Romanyszyn et al; 6,712,968 to Romanyszyn; 6,797,170 to Romanyszyn; 6,811,698 to Romanyszyn; 6,811,712 to Romanyszyn; and 7,087,178 to Romanyszyn et al.; and U.S. patent application Ser. No. 11/519,986 entitled “SYSTEMS AND METHODS FOR MICROBIOLOGICAL CONTROL IN METAL WORKING FLUIDS” to Kelsey et al., filed Sep. 12, 2006 and U.S. Provisional Patent Application No. 60/901,814 to Kelsey et al., entitled “SYSTEMS AND METHODS FOR TREATMENT OF WASTEWATER” filed Feb. 13, 2007, all of which are herein incorporated by reference.

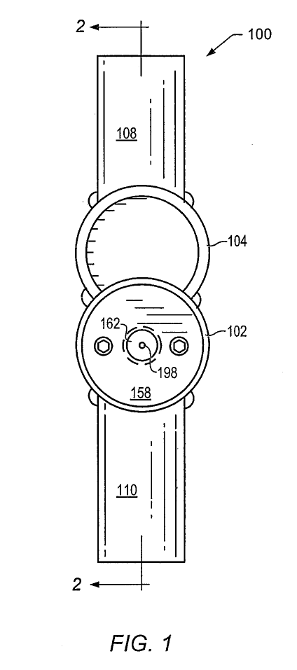

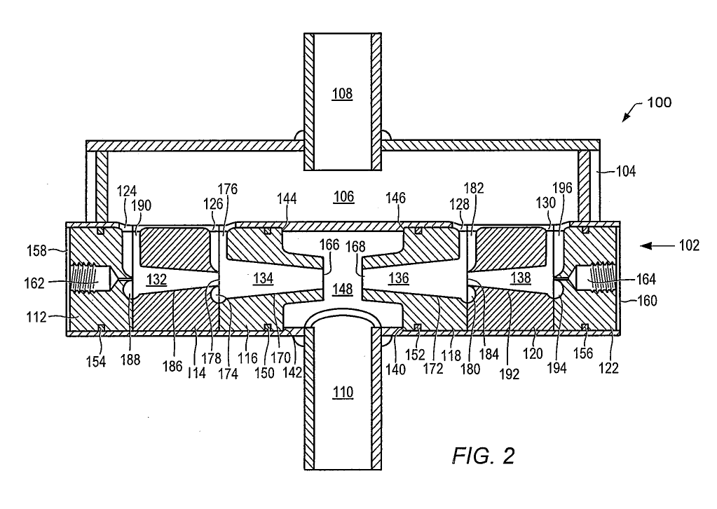

FIGS. 1 and 2 depict an embodiment of a fluid treatment system. Fluid treatment system 100 includes cylindrical body portions 102 and 104 formed integrally using any standard machining or molding process. Cylindrical body portion 104 defines chamber 106 and includes inlet 108 which may be attached to a stream source. Cylindrical body 102 defines a chamber and includes outlet 110 that attaches to any suitable conduit, reservoir, or any suitable fluid delivery means.

Cylindrical body portion 102 houses within its chamber vortex nozzle assembly blocks 112-122 (see FIG. 2). Additionally, cylindrical body 102 includes inlets 124-130 which communicate with chamber 106 of cylindrical body portion 104. The structure of vortex nozzle assembly blocks 112-122 are similar to those described in U.S. Pat. Nos. 4,261,521 to Ashbrook; 4,957,626 to Ashbrook et al., and 5,318,702 to Ashbrook. Each of vortex nozzle assembly blocks 112-122 are shaped using any standard machining or molding process to define a portion of vortex nozzles 132-138. Vortex assembly blocks 112, 114, and 116 define the first vortex nozzle unit and vortex assembly blocks 118, 120, and 122 define the second vortex nozzle unit.

Vortex nozzle assembly blocks 116 and 118 are inserted within the chamber defined by cylindrical body portion 102 until their inner edges contact ledges 140 and 142 in body portion 102. Ledges 140 and 142 prevent vortex nozzle assembly blocks 116 and 118 from being inserted the center of the chamber defined within cylindrical body portion 102. Vortex nozzle assembly blocks 116 and 118 reside within cylindrical body portion 102 such that they define chamber 148, which communicates with outlet 110. Vortex nozzle assembly blocks 116 and 118 include o-rings 150 and 152, respectively, which form a fluid seal between vortex nozzle assembly blocks 116 and 118 and the inner surface of cylindrical body portion 102.

After the insertion of vortex nozzle assembly blocks 116 and 118 to the position shown in FIG. 2, vortex nozzle assembly blocks 114 and 120 are inserted until they abut the rear portions of vortex nozzle assembly blocks 116 and 118, respectively. Finally, vortex nozzle assembly blocks 112 and 122 are inserted until they abut the rear portions of vortex nozzle assembly blocks 114 and 120, respectively. Vortex nozzle assembly blocks 112 and 122 include o-rings 154 and 156, respectively, which form a fluid seal between vortex nozzle assembly blocks 112 and 122 and the inner surface of cylindrical body portion 102.

Cylindrical body portion 102 includes plates 158 and 160 that fit within the entrances at either end of the cylindrical body portion. Plates 158 and 160 mount over vortex nozzle assembly blocks 112 and 122, respectively, using any suitable means (e.g., screws) to secure vortex nozzle assembly blocks 112-122 with the chamber defined by cylindrical body portion 102.

With vortex nozzle assembly blocks 112-122 positioned and secured within the chamber defined by cylindrical body portion 102, vortex nozzle assembly blocks 112-122 define vortex nozzles 132-138 and conduits 162 and 164. Vortex nozzles 134 and 136 are positioned in opposed relation so that a stream of water exiting their outlets 166 and 168, respectively, will collide approximately at the mid-point of chamber 148. Vortex nozzle assembly blocks 116 and 118 define frustro-conical inner surfaces 170 and 172 of vortex nozzles 134 and 136, respectively. The abutment of vortex nozzle assembly block 116 with vortex nozzle assembly block 114 defines circular portion 174 and channel 176, which communicates with inlet 126. Additionally, outlet 178 from vortex nozzle 132 communicates with circular portion 174 of vortex nozzle 134. Similarly, vortex nozzle blocks 118 and 120 define circular portion 180 and channel 182, which communicates with inlet 128, while outlet 184 from vortex nozzle 138 communicates with circular portion 180 of vortex nozzle 136.

Vortex nozzle assembly block 114 defines frustro-conical inner surface 186, while the abutment between vortex nozzle assembly blocks 112 and 114 defines circular portion 188 and channel 190, which communicates with inlet 124. Vortex nozzle assembly block 120 defines frustro-conical inner surface 192 and the abutment between vortex nozzle assembly blocks 120 and 122 defines circular portion 194 and channel 196, which communicates with inlet 130. Vortex nozzle assembly blocks 112 and 122 include conduits 162 and 164, respectively, which communicate to the exterior of cylindrical body portion 102 via opening 198 in plate 158 (see FIG. 1) and another opening in plate 160 (not shown). Conduits 162 and 164 permit additives to be introduced into vortex nozzles 132-138 during treatment of a fluid.

In operation, fluid is pumped into chamber 106 via inlet 108. The fluid flows from chamber 106 into channels 190, 176, 182, and 196 via inlets 124, 126, 128, and 130, respectively, of cylindrical body portion 102. Channels 190, 176, 182, and 196 deliver the fluid to circular portions 188, 174, 180, and 194, respectively, of vortex nozzles 132, 134, 136, and 138. Circular portions 188, 174, 180, and 194 impart a circular rotation to the water and deliver the circularly rotating water streams into frustro-conical inner surfaces 186, 170, 172, and 192, respectively. Frustro-conical inner surfaces 186, 170, 172, 192 maintain the circular rotation in their respective water stream and deliver the circularly rotating water streams to outlets 178, 166, 168, and 184, respectively, from vortex nozzles 132, 134, 136, and 138.

Due to the cascaded configuration of vortex nozzles 132 and 138, the water streams exiting outlets 178 and 184 enter vortex nozzles 134 and 136, respectively. Those circularly rotating streams combine with the circularly rotating streams within vortex nozzles 134 and 136 to increase the velocity of the circularly rotating streams therein. Additionally, as the streams exiting vortex nozzles 132 and 138 contact the streams within vortex 134 and 136, they strike the circularly rotating streams within vortex nozzles 134 and 136 such that they create compression waves therein.

The combined streams from vortex nozzles 132 and 134 and the combined streams from vortex nozzles 138 and 136 exit vortex nozzles 134 and 136 at outlets 166 and 168, respectively, and collide at approximately the mid-point of chamber 148. The streams are rotating oppositely as they exit vortex nozzles 134 and 136 because vortex nozzles 134 and 136 are positioned in an opposed relationship. As the exiting streams collide, additional compression waves are created which combine with the earlier compression waves to create compression waves having amplitudes greater than the original waves. The recombined water streams exit chamber 148 into outlet 110. The compression waves created by the collision of the exiting streams are sufficient to destroy at least a portion of biological contaminants present in the stream entering inlet 108. The compression waves are sufficient to reduce a size of particles in a stream, vaporize volatile materials, and/or compress particulate matter such that liquid is removed from the particulate matter.

Although the above description depicts a pair of cascaded nozzles, such description has been for exemplary purposes only, and, as will be apparent to those of ordinary skill in the art, any number of vortex nozzles may be used.

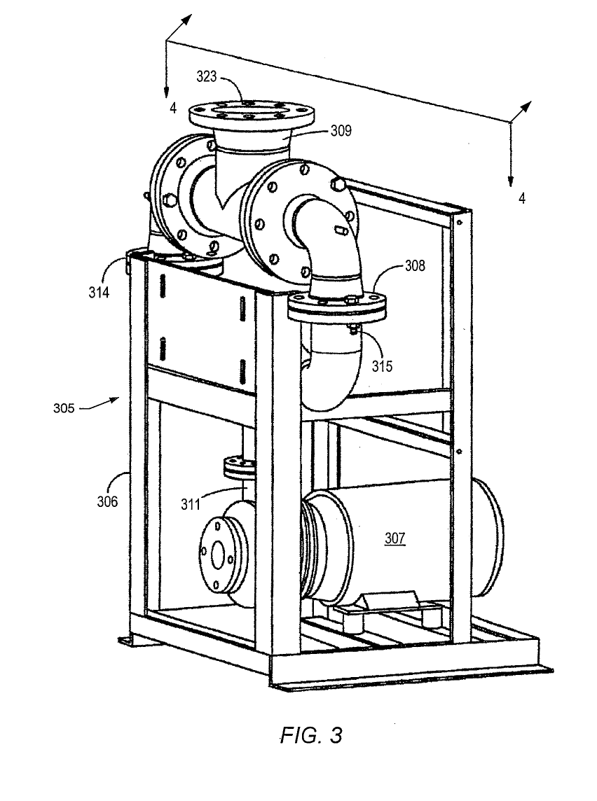

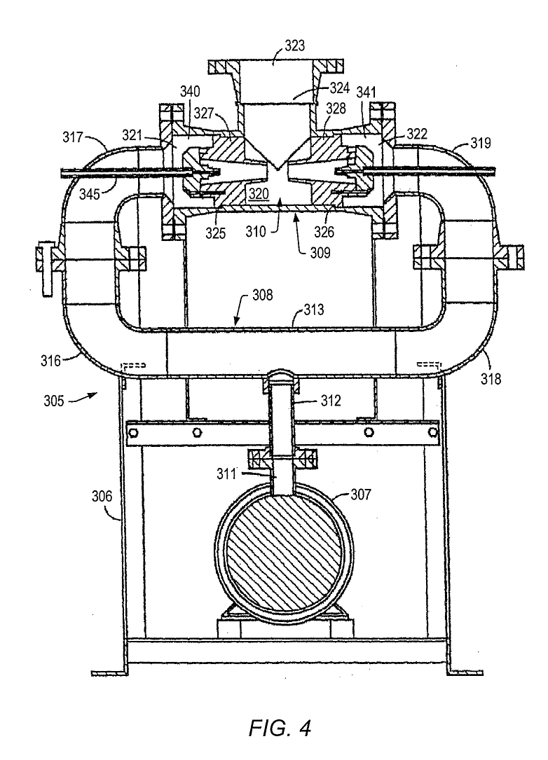

FIGS. 3 and 4 depict an embodiment of a fluid treatment system. Apparatus 305 includes frame 306 for supporting pump 307 and manifold 308. Pump 307 and manifold 308 may be coupled to frame 306 using any suitable coupling means (e.g., brackets). Apparatus 305 may include housing 309 secured to manifold 308 and vortex nozzle assembly 310. Vortex nozzle assembly 310 is disposed in housing 309.

Pump 307 includes outlet 311 and is any suitable pump capable of pumping fluid from a fluid source through apparatus 305. As shown, pump 307 delivers fluids, those of ordinary skill in the art will recognize many other suitable and equivalent means for delivering fluids, such as pressurized gas canisters may be used.

Manifold 308 includes inlet 312, diverter 313, and elbows 316, 317, 318, and 319. Inlet 312 couples to outlet 311 of pump 307 using any suitable means (e.g., flange and fasteners) to receive fluid flow from the pump. Inlet 312 fits within an inlet of diverter 313 and is held therein by friction, threading, welding, glue, or the like, to deliver fluid into the diverter. Diverter 313 receives the fluid flow therein and divides the fluid flow into a first fluid flow and a second fluid flow by changing the direction of fluid flow substantially perpendicular relative to the flow from inlet 312. Diverter 313 connects to elbows 316 and 318 by friction, threading, welding, glue, or the like, to deliver the first fluid flow to elbow 317 and the second fluid flow to elbow 319. Elbows 317 and 319 reverses its respective fluid flow received from the diverter 313 to deliver the fluid flow to housing 309. Conduits 345 and 346 may pass through portions of elbows 317, 319 to allow for pressure measurements and/or for the introduction of fluid or fluids to the streams entering housing 309. As shown, manifold 308 delivers fluid flow into housing 309, those of ordinary skill in the art will recognize many other suitable and equivalent means, such as two pumps and separate connections to housing 309 or a single pump delivering fluid into side portions of housing 309 instead of end portions.

Housing 309 includes inlets 321, 322, outlet 323, and ledgers 325 and 326. Housing 309 defines bore 320 along its central axis and bore 324 positioned approximately central to the midpoint of housing 309 and communicating with bore 320. Housing 309 is attached to elbows 317 and 319, using any suitable means, such as flanges and fasteners. Housing 309 receives a first fluid flow at inlet 321 and a second fluid flow at inlet 322. Outlet 323 is connectable to any suitable fluid storage or delivery system using well-known piping means.

Vortex nozzle assembly 310 resides within bore 320 and, in one embodiment, includes vortex nozzles 327 and 328, which are positioned within bore 320 of housing 309 in opposed relationship to impinge the first fluid flow with the second fluid flow, thereby treating the flowing fluid. With vortex nozzle 327 inserted into housing 309, vortex nozzle 327 and housing 309 define cavity 340, which receives the first fluid flow from elbow 317 and delivers the first fluid flow to vortex nozzle 327. Similarly, with vortex nozzle 328 inserted into housing 309, vortex nozzle 328 and housing 309 define cavity 341, which receives the second fluid flow from elbow 319 and delivers the second fluid flow to vortex nozzle 328.

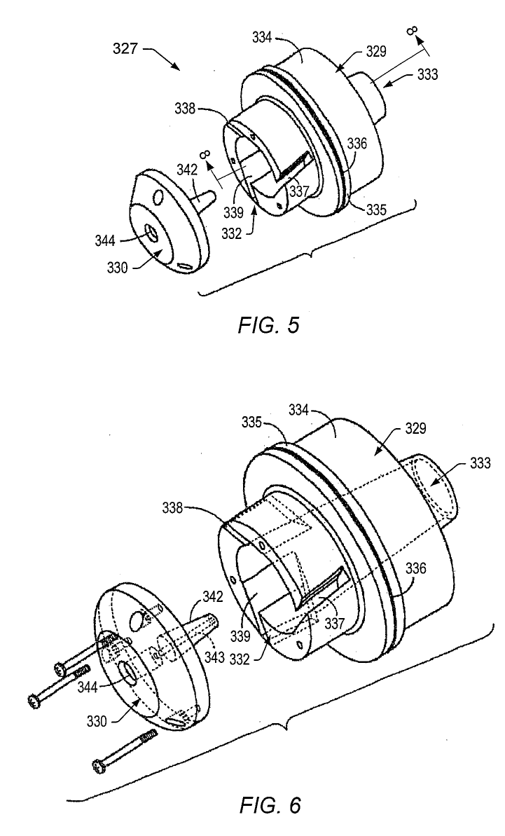

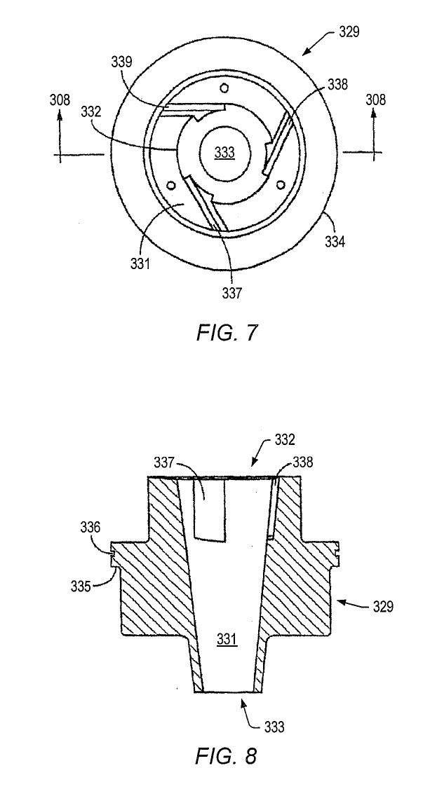

As illustrated in FIGS. 5-8, vortex nozzle 327 includes nozzle body 329 and end cap 330. For the purposes of disclosure, only vortex nozzle 327 will be described herein, however, it should be understood that vortex nozzle 328 may be identical in design, construction, and operation to vortex nozzle 327 and merely positioned within bore 320 of housing 309 in opposed relationship to vortex nozzle 327 to facilitate impingement of the second fluid flow with the first fluid flow.

Nozzle body 329, in one embodiment, is substantially cylindrical in shape and includes tapered passageway 331 located axially therethrough. The tapered passageway 331 includes inlet side 332 and decreases in diameter until terminating at an outlet side 333. The taper of the tapered passageway 331 is at least 1° and at most 90°. In some embodiments, the taper of the tapered passageway is at least 5° and at most 60°.

Nozzle body 329 includes shoulder 334 having raised portion 335 with groove 336 therein. Shoulder 334 is sized to frictionally engage vortex nozzle 327 with an interior surface of housing 309, while raised portion 335 of the vortex nozzle abuts ledge 325, thereby controlling the position of vortex nozzle 327 within the housing 309. Groove 336 receives a seal as o-ring to seal nozzle body 329 with housing 309 and, thus, vortex nozzle 327 within housing 309.

Nozzle body 329 further includes ports 337, 338, and 339 for introducing fluid into tapered passageway 331 of vortex nozzle 327. As shown, ports 337, 338, and 339 may be equally spaced radially about the nozzle body 329 beginning at inlet side 332. Although three ports 337, 338, and 339 are shown, those of ordinary skill in the art will recognize that any number of ports may be utilized. Furthermore, ports 337, 338, and 339 may be any shape suitable to deliver fluid into the tapered passageway 331, such as elliptical, triangular, D-shaped, and the like.

As shown, ports 337, 338, and 339 are tangential to the inner surface of tapered passageway 331 and enter tapered passageway 331 at the same angle as the taper of the tapered passageway, which enhances the delivery of the fluid into tapered passageway 331 and, ultimately, the distribution of the fluid around the tapered passageway. Although tangential ports 337, 338, and 339 are shown as being angled with the taper of the tapered passageway 331, those of ordinary skill in the art will recognize that the ports 337, 338, and 339 may enter tapered passageway 331 at any angle relative to the taper of the tapered passageway 331.

End cap 330 abuts the end of nozzle body 329, defining inlet side 332, to seal inlet side 332, and thereby permitting fluid to enter into the tapered passageway 331 through ports 337, 338, and 339. End cap 330 may include boss 342 formed integrally therewith or attached thereto at approximately the center of the inner face of the end cap. In this embodiment, the boss 342 is conical in shape and extends into tapered passageway 331 to adjust the force vector components of the fluid entering tapered passageway 331. Passageway 343 through boss 342 communicates with cavity 344 at approximately the center of the outer face of end cap 330. Conduit 345 (see FIG. 4) fits within cavity 344 to permit measurement of a vacuum within tapered passageway 331.

A flow of fluid delivered to vortex nozzle 327 enters tapered passageway 331 via ports 337, 338, and 339. The entry of fluid through ports 337, 338, and 339 imparts a rotation to the fluid, thereby creating a rotating fluid flow that travels down tapered passageway 331 and exits outlet side 333. Each port 337, 338, and 339 delivers a portion of the fluid flow to tapered passageway 331. The flow may be in multiple bands that are distributed uniformly in thin rotating films about tapered passageway 331. This minimizes pressure losses due to internal turbulent motion. Accordingly, vortex nozzle 327 provides for a more intense and stable impact of rotating fluid flow exiting outlet side 333 of tapered passageway 331 with fluid exiting vortex nozzle 327.

In some embodiments, a cross-sectional area of ports 337, 338, and 339 is less than the cross-sectional area of inlet side 332 of tapered passageway 331, which creates a reduced pressure within the rotating fluid flow. It should be understood to those of ordinary skill in the art that the size of ports 337, 338, and 339 may be varied based upon particular application requirements. The amount of vacuum created by ports 337, 338, and 339 may be adjusted utilizing boss 342 to alter the force vectors of the rotating fluid flow. Illustratively, increasing the size of boss 342 (e.g., either diameter or length) decreases the volume within the tapered passageway 331 fillable with fluid, thereby increasing the vacuum and, thus, providing the rotating fluid flow with more downward and outward force vector components.

In operation, manifold 308 is assembled as previously described and connected to pump 307. Vortex nozzles 327 and 328 are inserted in opposed relationship into housing 309 as previously described, and housing 309 is connected to manifold 308. Pump 307 pumps fluid from a fluid source and delivers the fluid into manifold 308, which divides the fluid into a first fluid flow and a second fluid flow. Manifold 308 delivers the first fluid flow into cavity 340 of housing 309 and the second fluid flow into cavity 341 of housing 309. The first fluid flow enters vortex nozzle 327 from cavity 340 via the ports of vortex nozzle 327. Vortex nozzle 327 receives the fluid therein and imparts rotation to the fluid, thereby creating a first rotating fluid flow that travels down vortex nozzle 327 and exits its outlet side. Similarly, the second fluid flow enters vortex nozzle 328 from cavity 341 via the ports of vortex nozzle 328. Vortex nozzle 328 receives the fluid therein and imparts rotation to the fluid, thereby creating a second rotating fluid flow that travels down vortex nozzle 328 and exits its outlet side. Due to the opposed relationship of vortex nozzles 327 and 328, the first rotating fluid flow impinges the second rotating fluid flow, resulting in the treatment of the fluid through the breaking of molecular bonding in the fluid and/or the reduction in size of solid particulates within the fluid. The treated fluid then exits outlet 323 of housing 309 and travels to a suitable fluid storage or delivery system.

Processing groundwater with any of the above-described fluid treatment systems will remove at least a portion of chemicals in the groundwater and also eradicate and/or lyse at least a portion of the biological contaminants in the contaminated water. In some embodiments, processing streams with any of the above-described fluid treatment systems may aerate the stream and/or reduce particle size of particulates of the treated stream. In certain embodiments, processing of the contaminated water with any of the above-described fluid treatment systems may remove enough contaminants such that the further treatment of the water may not be necessary.

In some embodiments, an additive may be added to one or more of the sets of nozzles to increase the amount of biological eradication and to reduce the amount of chemical contaminants. In certain embodiments, additives may be added to aid in the oxidation of contaminants.

In some embodiments, a fluid treatment system may include an inlet. The inlet may be coupled to a conduit and/or reservoir of a treatment system. The conduit and/or reservoir may supply contaminated groundwater to the treatment system. The concentration of contaminants in the reservoir and/or in lines coupling the fluid treatment system to the treatment system may be monitored. In some embodiments, a stream may be continuously processed by the fluid treatment system. That is the stream may be continuously drawn from a reservoir, into the fluid treatment system and returned to the reservoir, to control the concentration of biological contaminants, degree of aeration, reduction of volatile organic compounds, reduction of dissolved gasses, reduction in particulate size, or combinations thereof. Additionally, the concentration of biological contaminants, particulate size, dissolved gases, and/or VOCs in the fluid exiting the fluid treatment system may be monitored. If the fluid exiting the fluid treatment system is not within a predetermined acceptable range, the fluid may be recycled back into the fluid treatment system, an additive may be introduced into the fluid treatment system, and/or the amount of additive introduced to the fluid treatment system may be modified.

Pressure equalizing manifolds and/or stabilization chambers may be coupled to the fluid inlet of a fluid treatment system. In some embodiments, a pump may be coupled to the inlet to increase the velocity and/or pressure at which a stream enters a vortex nozzle unit. In other embodiments, a pump is not coupled to the system. The inlet may be coupled to each vortex nozzle unit. If a vortex nozzle unit includes two or more vortex nozzles, the inlet may be coupled to each of the individual vortex nozzles. In such a situation, a portion of the stream may concurrently flow into each vortex nozzle.

In some embodiments, the pressure of the stream in a vortex nozzle unit may be in the range of approximately 50 pounds per square inch (psi) to approximately 200 psi, approximately 80 psi to approximately 140 psi, or approximately 85 psi to approximately 120 psi. The stream may flow into a fluid treatment system at a flow rate of 1500 gallons per minute or less. In certain embodiments, a stream may flow into a fluid treatment unit at a flow rate of approximately 70 gallons to approximately 200 gallons per minute.

In some embodiments, hydrodynamic cavitation may occur as the stream passes through a vortex nozzle unit and/or when exit streams from the vortex nozzle units contact each other. In some embodiments, a plurality of vapor filled cavities and bubbles form if the pressure decreases to a level where the fluid boils. Boiling of the fluid may, in some embodiments, reduce an amount of dissolved gas (e.g., ammonia, hydrogen cyanide, and/or hydrogen sulfide), reduce an amount of halogenated hydrocarbons, and/or reduce an amount of volatile organic compounds in the stream (see TABLES 1 and 2).

TABLE 1

| Trichloroethane | | Trichloroethane | Percent |
|---|---|---|---|
| Initial | | Concentration | Reduction in |
| Concentration, | No. of | after | Trichloroethane |
| ppb | Passes | treatment, ppb | Concentration |
| 12 | 5 | 4 | 67% |
| 12 | 10 | <2 | >84% |
| 10 | 5 | 4 | 60% |
| 10 | 10 | <2 | >80% |
| 10 | 15 | <2 | >80% |
| 5.5 | 15 | <2 | >64% |
| 8 | 15 | <2 | >75% |
| 6.2 | 15 | <2 | >68% |

TABLE 2

| MTBE Initial | | MTBE Concentration | Percent Reduction |
|---|---|---|---|
| Concentration, | No. of | after treatment, | in MTBE |
| ppb | Passes | ppb | Concentration |
| 38.8 | 5 | 20.9 | 46% |

Fluid and cavitation bubbles may initially encounter a region of higher pressure when entering one or more of the vortex nozzle units in the system and encounter a vacuum area, at which point vapor condensation occurs within the bubbles and the bubbles collapse. The collapse of cavitation bubbles may cause hydrodynamic cavitations and pressure impulses. In some embodiments, the pressure impulses within the collapsing cavities and bubbles may be on the order of up to 1000 lbs/in². Hydrodynamic cavitation and/or other forces exerted on the fluid (e.g., pressure impulse, side walls of the nozzles) may cause changes in solubility of dissolved gasses, pH changes, formation of free radicals, and/or precipitation of dissolved ions such as phosphates, calcium, iron, and carbonate. In addition, shear forces created during hydrodynamic cavitation may destroy some biological contaminants and/or remove volatile materials from the stream being processed.

In some embodiments, hydrodynamic cavitation and/or the physical and mechanical forces created as the stream flows through the vortex nozzle units (e.g., shear collision and pressure/vacuum forces) may kill, lyse, or at least partially injure biological contaminants, remove volatile organic compounds, remove dissolved gases, change particulate size, or combinations thereof. When an organism is at least partially injured, the organism may be unable to maintain viability, growth, reproduction, metabolic activities, and/or adversely affect its environment. Biological contaminants in a stream may be killed and/or partially injured by high shear, collision, rapid pressure/vacuum changes, hydrodynamic cavitation forces, and/or other hydrodynamic changes in the fluid as it passes through the fluid treatment system. In some embodiments, biological contaminants may not be able to survive in the hydrodynamic cavitation region formed in the vortex nozzle unit and/or proximate an outlet of the vortex nozzle unit.

Additionally, when streams of fluids containing water collide with a speed of at least 450 mph collide (e.g., between 450 mph to 600 mph), at least some of the oxygen-hydrogen bonds in the water may be broken. The fragments from the collision may reform to produce hydrogen peroxide and other highly reactive intermediates. Hydrogen peroxide and/or the other highly reactive intermediates formed by hydrodynamic cavitation and the high-speed collision of water may destroy at least a portion of the biological contaminants in the fluid and reduce volatile organic compounds. The reactive intermediates may react with inorganic and organic impurities (e.g. chlorinated compounds, nitrates, ammonia, and/or phosphorous compounds) to form compounds that do not contaminant water bodies and/or enhance algae growth. For example, formation of hydrogen peroxide may dechlorinate chlorinated compounds in situ and/or oxidize oxygenated compounds in situ.

In some embodiments, one or more additives may be introduced into one or more of the vortex nozzle units via one or more additive inlets. Additives may include oxidation additives, biocides and nonbiocides. Oxidation additives may include, but are not limited to, hydrogen peroxide, compounds capable of releasing hydrogen peroxide, iron in combination with hydrogen peroxide, and/or ozone. In some embodiments, ultraviolet light may be directed towards the processing stream to catalyze and/or promote oxidation of contaminants. For example, hydrogen peroxide addition may be added to a water solution that includes MTBE during treatment in a fluid treatment system (see TABLE 3). Addition of hydrogen peroxide may enhance removal of the MTBE from the fluid.

TABLE 3

| | | MTBE Concentration | |
|---|---|---|---|
| MTBE Initial | | after treatment | Percent Reduction |
| Concentration, | No. of | in the presence of | in MTBE |
| ppb | Passes | H₂O₂, ppb | Concentration |
| 40.1 | 5 | 23.9 | 40% |
| 40.1 | 15 | 16.4 | 59% |
| 40.1 | 30 | 6.49 | 84% |
| 40.1 | 45 | 3.24 | 92% |

Biocides may include, but are not limited to, aldehydes, formaldehyde releasing compounds, halogenated hydrocarbons, phenolics, amides, halogenated amines and amides, carbamates, heterocyclic compounds including nitrogen and sulfur atoms at least in the ring portion of the structure, electrophilic active substances having a halogen group in the α position and/or in the vinyl position to an electronegative group, nucleophilic active substances having an alkyl group and at least one leaving group, surface active agents, and/or combinations thereof. Biocides may include, but are not limited to, linear, branched, or aromatic aldehydes such as glutaraldehyde; halogenated, methylated nitro-hydrocarbons such as 2-bromo-2-nitro-propane-1,3,-diol; halogenated amides such as 2,2-dibromo-3-nitrilopropionamide (DBNPA); thiazole; isothiazolinone derivatives such as 5-chloro-2-methyl-4 isothiazolin-3-one and 2-methyl-4-isothiazonlin-3-one; 1,2-dibromo-2,4-dicyanobutane, bis(trichloromethyl)sulfone, 4,5-dichloro-1,2-dithiol-3-one, 2-bromo-2-nitrostyrene; 2-n-octyl-4-isothiazolin-3-one; 4,5-dichloro-2-(n-octyl)-4-isothiazolin-3-one; 1,2-benzisothiazolin; o-phthaldehyde; 2-bromo-4′-hydroxyacetophenone; methylene bisthiocyanate (MBTC); 2-(thiocyanomethylthio)benzothiazole; 3-iodopropynyl-N-butylcarbamate; n-alkyl dimethyl benzyl ammonium chloride; didecyl dimethyl ammonium chloride; alkenyl dimethylethyl ammonium chloride; 4,5-dichloro-1,2-dithiol-3-one; decylthioethylamine; n-dodecylguanidine hydrochloride; n-dodecylguanidine acetate; 1-(3-chloroallyl)-3,5,7-triaza-1-azoniaadamantane chloride; bis(1,4-bromoacetoxy)-2-butene; bis(1,2-bromoacetoxy)ethane; diiodomethyl-p-tolylsulfone; sodium o-phenylphenate; tetrahydro-3,5-dimethyl-2H-1,3,5-hydrazine-2-thione; cationic salts of dithiocarbamate derivatives; 4-chloro-3-methyl phenol; 2,4,4′-trichloro-2′-hydroxy-diphenylether; poly(iminoimidocarbonyl-iminioimidocarbonyl-iminohexamethylene) hydrochloride; poly(osyethylene(dimethyliminio)ethylene-(dimethyliminio)ethylene dichloride; 4-chloro-2-(t-butylamino)-6-(ethylamino)-s-triazine; and/or combinations thereof.

In some embodiments, it may not be desirable to use biocides in a stream due to the health problems exposure to the biocides may cause. In some embodiments, nonbiocides may be introduced into one or more of the sets of nozzles. Non-biocides may include surfactants, emulsifiers, and certain polymeric compounds. Non-biocidal additives may not kill microorganisms but may increase the speed and/or quantity of bacteria killed in the system. Although non-biocidal additives may not kill bacteria alone, the use of such materials in a fluid treatment system may increase the quantity of bacteria killed when compared to using the fluid treatment system in the absence of a non-biocidal additive. In certain embodiments, an additive may include a cationic polymeric product known as PERFORM® 1290 (Hercules Incorporated, Wilmington, Del., USA). (See TABLE 4)

TABLE 4

| | | | Percent |
|---|---|---|---|
| | | | Change in |
| | Concentration of | Treatment | Bacteria |
| Treatment | Additive | Time | Population |
| Perform ® 1290 | 0.5 ppm for 10 min. | 30 min. | +5.00 |
| (1.5 ppm) | 0.5 ppm for 10 min. | | |
| | 0.5 ppm for 10 min. | | |
| Perform ® 1290 | 0.5 ppm for 10 min. | 30 min. | −99.47 |
| (1.5 ppm) + fluid | 0.5 ppm for 10 min. | | |
| treatment system | 0.5 ppm for 10 min. | | |

In certain embodiments, DTEA (2-decylthioethylamine), and/or DTEA II (1-(decylthio)ethylamine), may be used as an additive. DTEA and/or DTEA II may disrupt coenzyme materials in cells necessary for photosynthesis and thus injure the cells. The concentration and/or formulation of DTEA and/or DTEA II used in trace amounts without a fluid treatment system may not be sufficient to act as an effective biocide. DTEA and/or DTEA II, however, may increase the bacteria killing effectiveness of the system when used with the fluid treatment system (See TABLE 5).

TABLE 5

| | | | Percent |
|---|---|---|---|
| | | | Change in |
| | Concentration of | Treatment | Bacteria |
| Treatment | Additive | Time | Population |
| DTEA II | 1.0 ppm for 10 min. | 30 min. | +6.77 |
| (3.00 ppm) | 1.0 ppm for 10 min. | | |
| | 1.0 ppm for 10 min. | | |
| DTEA II | 1.0 ppm for 10 min. | 30 min. | −98.62 |
| (3.0 ppm) + | 1.0 ppm for 10 min. | | |
| fluid treatment | 1.0 ppm for 10 min. | | |
| system | | | |

In some embodiments, VANTOCIL® 1B (poly iminoimidocarbonyl-iminoimidocarbonyl-iminohexamethylene hydrochloride, (ARCH Chemicals, Newark, Del.) may be used with the fluid treatment system as an additive in trace amounts. (See TABLE 6)

TABLE 6

| | | | Percent |
|---|---|---|---|
| | | | Change in |
| | Concentration of | Treatment | Bacteria |
| Treatment | Additive | Time | Population |
| Vantocil ® 1B | 0.1 ppm for 10 min. | 20 min. | −66.28 |
| | 0.2 ppm for 10 min. | | |
| Vantocil ® 1B + | 0.1 ppm for 10 min. | 20 min. | −97.57 |
| the fluid treatment | 0.2 ppm for 10 min. | | |
| system | | | |

An amount of additive may be introduced into the fluid treatment system to reduce a microbiological content of the stream to a desired level or range. In some embodiments, approximately 0.1 to 6 ppm of additive may be introduced into the inlet of the fluid treatment system stream. The use of an additive may increase the system's effectiveness in eradicating biological contaminants. An additive may be able to increase a fluid treatment system's effectiveness in eradicating, lysing, reducing or controlling biological contaminants by a greater amount than the effectiveness of the additive alone, the fluid system alone or a combination of the additive alone and the fluid system alone.

In fluid treatment systems described herein, a “pass” through the fluid treatment system is defined as passing a fluid through the system for a time sufficient to pass the entire volume of a reservoir through the system. For example, if the reservoir to be treated by the fluid treatment system is a 20-gallon reservoir, a “pass” is complete when 20 gallons of fluid from the reservoir have gone through the fluid treatment system.

In some embodiments, all or a portion of the stream flowing out of the fluid treatment system may be recycled through the fluid treatment system via one or more recycle lines. Recycling the stream through the fluid treatment system for a number of passes may allow for significant reduction of the concentration of bacteria and other microorganisms in the stream. In some embodiments, a portion of the stream exiting the fluid treatment system may be mixed with a portion of the stream entering the fluid treatment system the inlet.

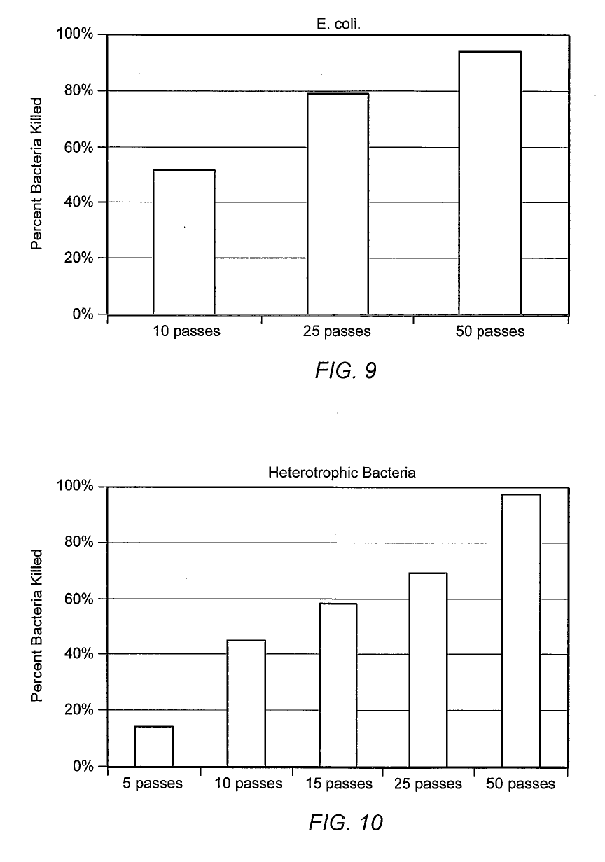

FIG. 9 depicts examples of the percent of bacteria killed when Escherichia coli is subjected to multiple passes through the fluid treatment system. In this experiment, a fluid that includes E. coli bacteria was subjected to 10, 25, and 50 passes through a fluid treatment system commercially available from VRTX™, Schertz, Tex. The bacteria population was determined before and after the fluid was treated with the fluid treatment system using Method 9215B from the “Standard Methods for the Examination of Water and Wastewater.” As depicted in FIG. 9, the percentage of bacteria killed increased as the number of passes through the fluid treatment system increased. A similar test was performed on a fluid that included a mixed community of heterotrophic bacterial species (See FIG. 10).

In some embodiments, the system may be monitored and/or adjustments made as needed to control the concentration of biological contaminants and/or VOCs in the streams. For example, concentration of VOCs (e.g., MTBE and/or TCE) may be monitored continuously or periodically by employing a gas chromatograph. Monitoring the concentration of VOCs continuously or periodically may allow for the adjustment of flow rates, number of recycles through the system, and/or the amount and/or type of additive introduced into the system so that the concentration of VOCs in the stream exiting the fluid treatment system is at or below a desired level.

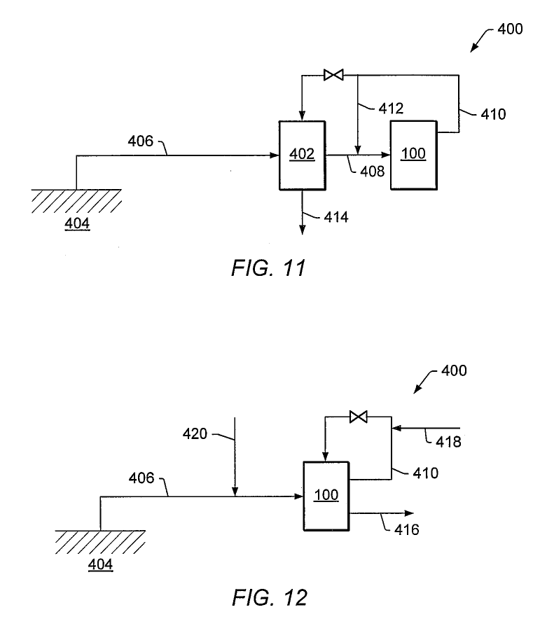

In some embodiments, contaminated water system 400 includes a reservoir 402 and a fluid treatment system 100 coupled to the reservoir, as depicted in FIG. 11. Reservoir 402 receives fluid from groundwater storage (e.g., underground reservoirs and/or aquifers) and/or surface storage areas 404 via conduit 406. Conduit 408 may couple the reservoir to an inlet of fluid treatment system 100. Additional conduit 410 may couple the fluid treatment system back to the reservoir. During use, at least a portion of the water exiting the fluid treatment system may be recycled back into the fluid treatment system, rather than being sent to the reservoir or distributed to other processing units. Recycle conduit 412 may be coupled to exit conduit 410 to allow the contaminated water to be recycled. A three-way valve may be positioned at the intersection of conduits 410 and 412 to control the flow of the contaminated water. Treated water may exit reservoir 402 via conduit 414.

In other embodiments, reservoir 402 is not needed, as shown in FIG. 12. Fluid treatment system 100 receives fluid from groundwater storage (e.g., underground reservoirs and/or aquifers) and/or surface storage areas 404 via conduit 406. Additional conduit 410 may recycle the contaminated water back to fluid treatment system 100. During use, at least a portion of the water exiting the fluid treatment system may be recycled back into the fluid treatment system, rather than being sent to storage facilities and/or other processing units via conduit 416. A three-way valve may be positioned in conduit 410 to control the flow of the recycled contaminated water to fluid treatment system 100. Additives may be introduced to fluid treatment system 100 via conduit 418 and/or 420. In some embodiments, additive conduits 418 and 420 are not needed.

In an embodiment, the amount of halogenated hydrocarbons, dissolved gas and/or VOCs in the contaminated water may be assessed prior to introducing the contaminated water into the fluid treatment system. For example, a sample from reservoir 402 and/or fluid treatment system 100 may be removed and tested for concentration of VOCs, halogenated hydrocarbons and/or dissolved gases. Alternatively, in-line monitoring equipment may be coupled to conduits 410 and 412 to allow continuous monitoring of the contaminants in reservoir 402 and/or fluid treatment system 100. In some embodiments, once a concentration of contaminants is assessed, a number of passes through the fluid treatment system may be estimated and/or oxidation additives may be added to fluid treatment system 100 and/or reservoir 402 via conduits 418 and/or 420.

In this patent, certain U.S. patents and other materials (e.g., articles) have been incorporated by reference. The text of such U.S. patents and other materials is, however, only incorporated by reference to the extent that no conflict exists between such text and the other statements and drawings set forth herein. In the event of such conflict, then any such conflicting text in such incorporated by reference U.S. patents and other materials is specifically not incorporated by reference in this patent.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A contaminated water treatment system, comprising:
one or more fluid treatment systems configured to treat a contaminated water stream, wherein one or more of the fluid treatment systems comprises a first vortex nozzle unit and a second vortex nozzle unit positioned in substantially opposed relation to the first vortex nozzle unit so that a stream exiting the first vortex nozzle unit contacts a stream exiting the second vortex nozzle unit; and
wherein contacting the contaminated water stream exiting the first vortex nozzle unit with the contaminated water stream exiting the second vortex nozzle unit removes at least a portion of one or more volatile organic compounds in the contaminated water stream.

2. A contaminated water treatment system, comprising:
a reservoir, wherein the reservoir is configured to receive contaminated water from one or more storage areas;
a fluid treatment system, the fluid treatment system comprising a first vortex nozzle unit and a second vortex nozzle unit positioned in substantially opposed relation to the first vortex nozzle unit so that a stream exiting the first vortex nozzle unit contacts a stream exiting the second vortex nozzle unit;
a conduit coupling an outlet of the reservoir to an inlet of the fluid treatment system; and
a fluid treatment conduit coupling an outlet of the fluid treatment system to the reservoir; and
wherein contacting the contaminated water stream exiting the first vortex nozzle unit with the contaminated water stream exiting the second vortex nozzle unit removes at least a portion of one or more volatile organic compounds in the contaminated water stream.

3. The system of claim 2, further comprising a conduit coupled to the reservoir and one or more of the storage areas.

4. The system of claim 2, wherein the first vortex nozzle unit has a single vortex nozzle.

5. The system of claim 2, wherein at least one of the first vortex nozzle units has a plurality of vortex nozzles.

6. The system of claim 2, wherein the plurality of vortex nozzles are in a cascade configuration.

7. The system of claim 2, further comprising an additive conduit coupled to at least one of the first vortex nozzle unit and the second vortex nozzle unit, wherein the additive conduit is configured to allow addition of an additive to the contaminated water stream as the contaminated water stream passes through the first and/or second vortex nozzle unit.

8. The system of claim 2, wherein at least one vortex nozzle unit comprises a vortex nozzle comprising a nozzle body including a passageway therethrough, a plurality of inlet ports, and an end cap attached to the nozzle body.

9. The system of claim 2, wherein a first portion of a contaminated water flows through a first set of nozzles and a second portion of contaminated water flows through a second set of nozzles.

10. A method for treating contaminated water, comprising:
introducing a contaminated water stream to a fluid treatment system, the fluid treatment system comprising a first vortex nozzle unit and a second vortex nozzle unit positioned in substantially opposed relation to the first vortex nozzle unit;
flowing a first portion of the contaminated water stream through the first vortex nozzle unit;
flowing a second portion of the contaminated water stream through the second vortex nozzle unit; and
contacting the first portion of the contaminated water stream exiting the first vortex nozzle unit with the second portion of the contaminated water stream exiting the second vortex nozzle unit; and
wherein contacting the contaminated water stream exiting the first vortex nozzle unit with the contaminated water stream exiting the second vortex nozzle unit removes at least a portion of one or more volatile organic compounds in the contaminated water stream.

11. The method of claim 10, wherein the first vortex nozzle unit has a single vortex nozzle.

12. The method of claim 10, wherein at least one of the first vortex nozzle units has a plurality of vortex nozzles.

13. The method of claim 10, wherein the plurality of vortex nozzles are in a cascade configuration.

14. The method of claim 10, further comprising an additive conduit coupled to the first vortex nozzle unit, wherein the additive conduit is configured to allow addition of an additive to the contaminated water stream as the contaminated water stream passes through the first vortex nozzle unit.

15. The method of claim 10, wherein the first vortex nozzle unit comprises a vortex nozzle comprising a nozzle body including a passageway therethrough, a plurality of inlet ports, and an end cap attached to the nozzle body.

16. The method of claim 10, wherein the first vortex nozzle unit comprises a vortex nozzle comprising a nozzle body including a passageway therethrough, a plurality of inlet ports, and an end cap attached to the nozzle body.

17. The method of claim 10, wherein the contaminated water comprises ground water.

18. The method of claim 10, wherein the contaminated water comprises surface water.

19. The method of claim 10, wherein at least one of the volatile organic compounds comprises ether oxygenates.

20. The method of claim 10, wherein at least one of the volatile organic compounds comprises halogenated hydrocarbons.

21. The method of claim 10, wherein at least one of the volatile organic compounds comprises hydrocarbons.

22. The method of claim 10, wherein at least one of the volatile organic compounds comprises ether oxygenates, alcohol oxygenates, halogenated hydrocarbons, hydrocarbons or mixtures thereof.

23. The method of claim 10, wherein at least one of the volatile organic compounds comprises methyl tertiary-butyl ether, tertiary-amyl methyl ether, dimethyl ether, ethyl tertiary-butyl ether, tertiary-amyl ethyl ether, diisopropyl ether, or mixtures thereof.

24. The method of claim 10, wherein at least one of the volatile organic compounds comprises alcohol oxygenates.

25. The method of claim 10, wherein at least one of the volatile organic compounds comprises tertiary-butyl alcohol, ethanol, methanol, tertiary-amyl alcohol, or mixtures thereof.

26. The method of claim 10, wherein at least one of the volatile organic compounds comprises trichloroethane, dichlorethane, and/or methylene chloride.

27. The method of claim 10, wherein at least one of the volatile organic compounds comprises methyl tertiary-butyl ether.

28. The method of claim 10, wherein at least one of the volatile organic compounds comprises tricholorethane.

29. The method of claim 10, further comprising transporting the contaminated water from a reservoir coupled to the fluid treatment system.

30. The method of claim 10, further comprising transporting contaminated water from one or more storage areas to the fluid treatment system.
